(19) United States
(12) Patent Application Publication
(10) Pub. No.: US 2006/0119764 A1
(43) Pub. Date: Jun. 8, 2006

(54) Flat fluorescent lamp and liquid crystal display apparatus having the same

(76) Inventors: Joong-Hyun Kim, Yongin-si (KR); Sang-Yu Lee, Yongin-si (KR); In-Sun Hwang, Suwon-si (KR)

Correspondence Address: CANTOR COLBURN, LLP, 55 GRIFFIN ROAD SOUTH, BLOOMFIELD, CT, 06002, US

(21) Appl. No.: 11/261,851

(22) Filed: Oct. 28, 2005

(30) Foreign Application Priority Data
Nov. 10, 2004 (KR) 2004-91363

(51) Int. Cl. G02F 1/1335

(52) U.S. Cl. 349/70

(57) ABSTRACT

A flat fluorescent lamp and liquid crystal display apparatus having the same is provided. The flat fluorescent lamp includes a first substrate and a second substrate combined with the first substrate to form a discharge space between the first and second substrates. The flat fluorescent lamp also includes a getter disposed in the discharge space. The getter includes a body portion and a wing portion for securing the body portion.

The present application claims priority to Korean Patent Application No. 2004-91363 filed on Nov. 10, 2004, the contents of which are herein incorporated by reference in its entirety.

### BACKGROUND OF THE INVENTION

1. Field of the Invention

The present invention relates generally to a flat fluorescent lamp for generating light for displaying images and a liquid crystal display apparatus having the flat fluorescent lamp. More particularly, the present invention relates to a flat fluorescent lamp comprising a getter configured for use without an exhaustion tube and a liquid crystal display apparatus having the flat fluorescent lamp.

2. Description of the Related Art

Generally, a liquid crystal display (LCD) apparatus, one of flat display apparatuses, displays images by using liquid crystal. The LCD apparatus has many merits, for example, thin thickness, lightweight, low power consumption, low driving voltage, etc., making it ideal for use in a variety of industrial fields.

The LCD apparatus is considered to be a non-emissive display apparatus in which light for displaying an image is not generated from a display panel, but rather the LCD apparatus requires a light source for providing light to the display panel.

A cold cathode fluorescent lamp (CCFL) having a slender and cylindrical shape is widely utilized as a conventional light source. However, recent trends in the industry to produce larger LCD apparatuses necessarily result in the need for a greater number of CCFLs. As a consequence, manufacturing costs for the LCD apparatus is increased and optical characteristics, such as luminance uniformity characteristics are deteriorated.

Intensive research for solving the above-mentioned problems has been focused on designing a flat fluorescent lamp, because the flat fluorescent lamp generates planar light (not linear light).

The flat fluorescent lamp includes a lamp body including a plurality of discharge spaces and electrodes for applying a discharge voltage to the lamp body. A discharge voltage of which frequency is inverted by an inverter generates a plasma discharge in each of the discharge spaces of the lamp body, and as result, ultraviolet rays are radiated from the discharge spaces. The ultraviolet rays excite electrons of the fluorescent layer on an internal surface of the fluorescent lamp, thereby generating a visible light.

An exhaustion tube is formed on a surface of the lamp body, and air in the discharge space is exhausted and a discharge such as a mercury gas is supplied into the discharge space through the exhaustion tube. The discharge gas is supplied into the conventional flat fluorescent lamp having the above-mentioned structure as follows. Initially, air in the discharge areas is exhausted through the exhaustion tube, and the discharge gas is injected into the discharge space through the exhaustion tube. Then, after a getter comprising mercury is inserted into the exhaustion tube, the exhaustion tube is sealed. When a radio frequency wave is applied to the getter in the exhaustion tube, the mercury gas uniformly scatters into the discharge space. At the end, the exhaustion tube is cut off from the lamp body.

However, although the exhaustion tube is removed from the lamp body, a residue of the exhaustion tube may remain, thereby increasing a thickness of the flat fluorescent lamp. Moreover, the exhaustion tube may be broken during the manufacturing process of the flat fluorescent lamp, thereby decreasing productivity in its manufacture.

### BRIEF SUMMARY OF THE INVENTION

The present invention provides a flat fluorescent lamp for improving an ability of mounting a getter thereto.

The present invention provides an LCD apparatus having the above flat fluorescent lamp.

According to an exemplary embodiment of the present invention, there is provided a flat fluorescent lamp including a first substrate and a second substrate combined with the first substrate to form a discharge space between the first and second substrates. The flat fluorescent lamp also includes a getter disposed in the discharge space. The getter includes a body portion and a wing portion for securing the body portion to the first substrate. As an exemplary embodiment, the body portion of the getter includes a source having an amalgam material and a cover surrounding the source, and the source includes a gathering alloy to which impurities in the discharge space are adhered. The second substrate includes a plurality of protruded portions arranged substantially parallel with and spaced apart from each other, so that an interval portion is formed between adjacent ones of the protruded portions, and the first substrate makes contact with the interval portion and an edge portion of the second substrate, thereby forming the discharge space between the first substrate and a recessed portion of which surface is opposite to a surface of corresponding one of the protruded portions of the second substrate. The wing portion extends in two different directions from the body portion and is symmetrical with respect to the body portion. The wing portion of the getter includes a bended portion, so that the body portion of the getter is spaced apart from the first substrate.

The flat fluorescent lamp may further comprise a reflective layer formed on a top surface of the first substrate facing a bottom surface of the second substrate, a first fluorescent layer formed on the reflective layer, and a second fluorescent layer formed on the bottom surface of the second substrate. The reflective layer and the first fluorescent layer may have an opening for receiving the getter, and a thickness of the wing portion is substantially equal to a thickness of the reflective layer and the first fluorescent layer.

As a modified exemplary embodiment, a bottom surface of the second substrate corresponding to the interval portion between which the getter is disposed is partially removed, so that a holding space for receiving the wing portion of the getter is formed between the first substrate and the interval portion of the second substrate.

According to another exemplary embodiment of the present invention, there is provided a liquid crystal display apparatus including a flat fluorescent lamp. The flat fluorescent lamp includes a first substrate, a second substrate combined with the first substrate to form a discharge space between the first and second substrates, and a getter positioned in the discharge space. The getter includes body portion and a wing portion for securing the body portion to the first substrate. The liquid crystal display apparatus also includes an inverter and a liquid crystal panel. The inverter applies a discharge voltage to the flat fluorescent lamp. The liquid crystal panel displays images by using light generated from the flat fluorescent lamp.

The liquid crystal display apparatus may further include a diffusing plate positioned over the flat fluorescent lamp and an optical sheet positioned over the diffusing plate. The diffusing plate diffuses light generated from the flat fluorescent lamp. The liquid crystal display apparatus further still includes a receiving container receiving the flat fluorescent lamp, an insulating member interposed between the flat fluorescent lamp and the receiving container, a first mold securing the flat fluorescent lamp and supporting the diffusing plate, and a second mold securing the diffusing plate and the optical sheet and supporting the liquid crystal display panel.

In accordance with an exemplary embodiment, the flat fluorescent lamp is configured such that the need for an exhaustion tube to mount the getter is eliminated, thereby decreasing a thickness of the flat fluorescent lamp and preventing a processing failure often caused by the exhaustion tube. In addition, the getter is more stably secured to the substrate due to the wing portion thereof.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view illustrating a flat fluorescent lamp in accordance with an exemplary embodiment of the present invention;

FIG. 2 is a cross-sectional view illustrating an assembled structure of the flat fluorescent lamp of FIG. 1 taken along line I-I′;

FIG. 3 is an enlarged perspective view illustrating the getter in FIG. 1;

FIG. 4 is a cross-sectional view illustrating a flat fluorescent lamp according to another exemplary embodiment of the present invention;

FIG. 5 is a perspective view illustrating the getter shown in FIG. 4;

FIG. 6 is a cross-sectional view illustrating a flat fluorescent lamp according to still another exemplary embodiment of the present invention;

FIG. 7 is an exploded perspective view illustrating a liquid crystal display apparatus according to an exemplary embodiment of the present invention; and

FIG. 8 is a cross-sectional view illustrating the liquid crystal display apparatus shown in FIG. 7.

### DETAILED DESCRIPTION OF THE INVENTION

Hereinafter, the exemplary embodiments of the present invention will be described in detail with reference to the accompanying drawings.

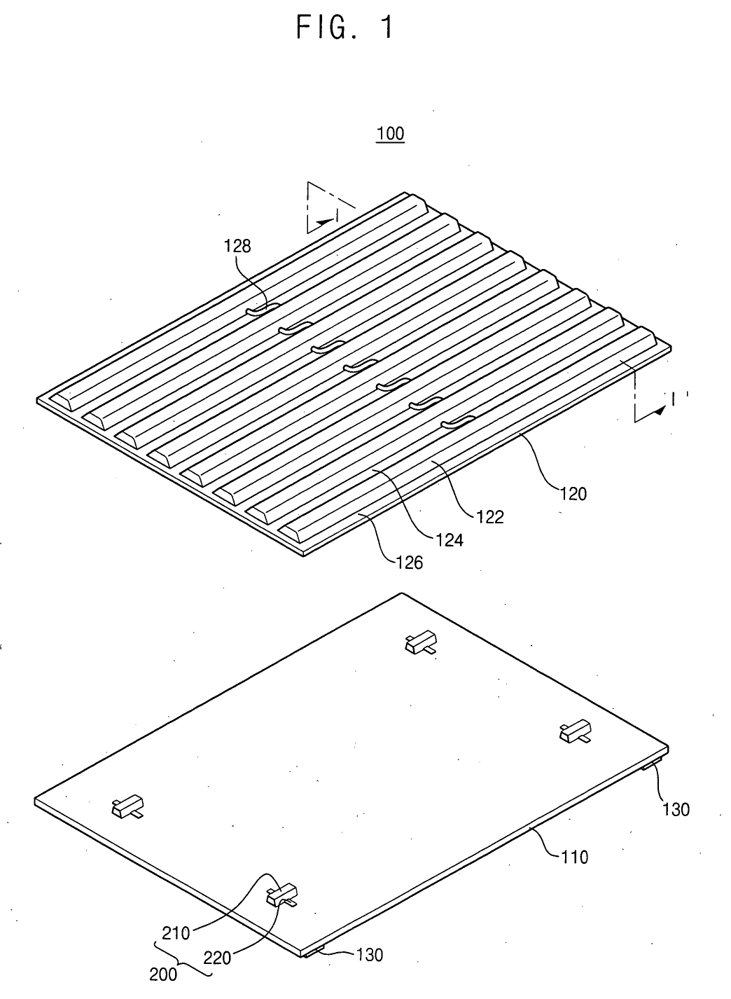

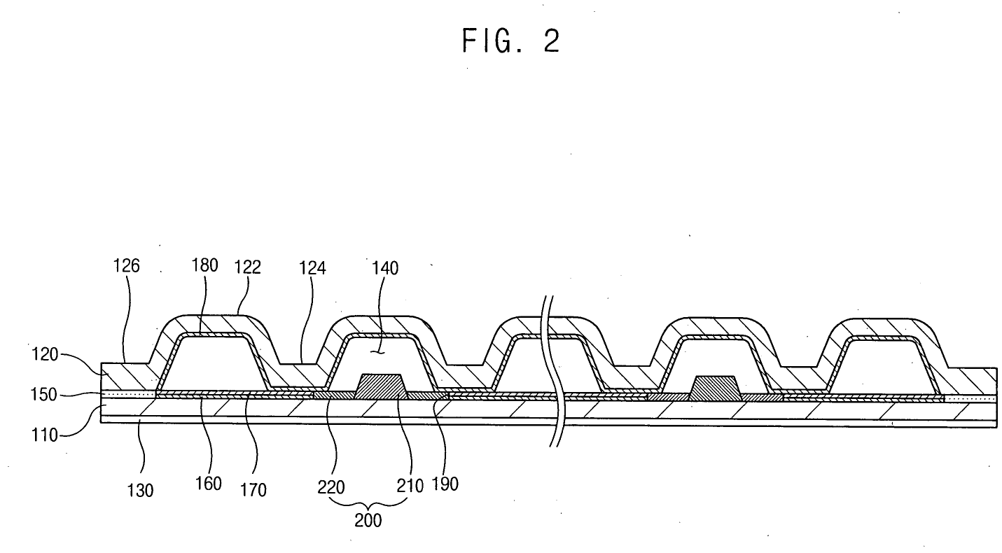

FIG. 1 is an exploded perspective view illustrating a flat fluorescent lamp in accordance with an exemplary embodiment of the present invention and FIG. 2 is a cross-sectional view illustrating an assembled structure of the flat fluorescent lamp of FIG.1 taken along line I-I′.

Referring to FIGS. 1 and 2, a flat fluorescent lamp 100 according to an exemplary embodiment of the present invention includes a first substrate 110, a second substrate 120 and a getter 200. The second substrate 120 is combined with the first substrate 110, and a plurality of discharge spaces is formed between the first and second substrates 110 and 120. The getter 200 is positioned in at least one of the discharge spaces, so that a mercury gas is provided into one of the discharge spaces 140 (FIG. 2) as will be described. As shown in FIGS. 1 and 2, the getter 200 exemplarily includes a body portion 210 and a wing portion 220 for securing the body portion 210 to the first substrate 110.

As an exemplary embodiment, the first substrate 110 includes, e.g., a rectangular-shaped plate comprised of glass. In addition, the first substrate 110 may further include an ultraviolet blocking material so as to prevent ultraviolet light generated by a plasma discharge from leaking externally out of the discharge space.

The second substrate 120 is combined with the first substrate 110, and the discharge space 140 is formed between a top surface of the first substrate 110 and a bottom surface of the second substrate 120. Light is radiated in the discharge space 140 during a plasma discharge in the discharge space 140. The second substrate 120 comprises a transparent material such as a glass material, so that the light generated from the discharge space 140 passes through the second substrate 120 and is emitted outside of the flat fluorescent lamp 100. The second substrate 120 may further include an ultraviolet blocking material so as to prevent ultraviolet light generated by a plasma discharge from leaking externally out of the discharge space 140.

As an exemplary embodiment, a plurality of recessed portions 122 are formed on the bottom surface of the second substrate 120, which spaced apart from each other. The recessed portions 122 are substantially parallel with each other. The recessed portion 122 is protruded in view of a top surface of the second substrate 120, so that the recessed portion 122 in view of the bottom surface may be referred to as a protruded portion in view of the top surface hereinafter. That is, the surface of the recessed portion 122 is a portion of the bottom surface of the second substrate 120 and the surface of the protruded portion is a portion of the top surface of the second substrate 120, so that the surface of the recessed portion 122 is opposite to that of the protruded portion. When the first and second substrates 110 and 120 are combined with each other, the second substrate 120 makes contact with the first substrate 110 at a plurality of interval portions 124 each formed between adjacent ones of the recessed portions 122, and is spaced apart from the first substrate 110 at the recessed portions 122 by a predetermined recessed depth. Accordingly, the discharge space 140 is formed between the first substrate 110 and the recessed portion 122 of the second substrate 120. An edge portion 126 of the second substrate 120 is also combined with the first substrate 110, and a sealing member (not shown) is formed on the edge portion of the second substrate 120. In the present embodiment, the second substrate 120 having the above-described structure is formed through a molding process. A base substrate having a plate like shape as the first substrate 110 is heated to a predetermined temperature, and a shape of a predetermined mold is inscribed on a surface of the heated base substrate, thereby forming the second substrate 120 including the recessed portions 122. While the above exemplary embodiment describes the second substrate created by the molding process to a heated base substrate, the second substrate could also be created by an air blowing onto a surface of the heated base substrate in accordance with a desirable shape or any other modified technique known to one of ordinary skill in the art. In the present embodiment, a cross sectional surface of the second substrate 120 is represented as a consecutive series of arches, as shown in FIG. 2. However, the cross sectional surface of the second substrate 120 may be represented in various shapes such as a semicircular shape, a rectangular shape, or the like, as would be known to one of ordinary skill in the art.

A connecting member 128 may be further disposed on a top surface of the second substrate 120. The protruded portions of the second substrate 120, which are adjacent to each other, are connected with each other by means of a connecting member 128. Thus the discharge spaces 140, which are adjacent to each other, are connected through the connecting members 128. At least one connecting member 128 is positioned on the interval portion 124 of the top surface of the second substrate 120. Air in the discharge space 140 is exhausted through the connecting member 128, and the discharge gas for generating a plasma discharge is supplied into the discharge space 140 through the connecting member 128. The connecting member 128 may be formed in the molding process for the second substrate 120 simultaneously with the protruded members of the second substrate 120. The connecting member 128 may have various shapes provided that the discharge spaces 140 are sufficiently connected to each other through the connecting member 128. In the embodiment of FIG. 1, the connecting member 128 has an S shape.

The first and second substrates 110 and 120 are secured to each other using, e.g., an adhesive medium 150. The adhesive 150 may comprise frit, the melting point of which is lower than that of a glass. The frit may be a mixture of glass and metal. The adhesive 150 is interposed between the first and second substrates 110 and 120 along the edge portion 126 thereof and a plastic process is performed on the adhesive 150, so that the first and second substrates 110 and 120 are firmly combined with each other. The adhesive 150 is disposed under the edge portion 126 of the second substrate 120. In this embodiment, for example, no adhesive is disposed under the interval portions 124 of the second substrate 120. Rather, the interval portions 124 of the second substrate 120 adhere closely to the first substrate 110 by a pressure difference between an internal pressure and an external pressure of the discharge space 140.

When air in the discharge space 140 is exhausted through the connecting member 128 after combining the first and second substrates 110 and 120, an inside of the discharge space 140 comprises a vacuum-like quality. Thereafter, various discharge gases for accelerating a plasma discharge are provided into the discharge spaces 140 through the connecting member 128. Examples of the discharge gas may include a neon gas, an argon gas, etc. These may be used alone or in combinations thereof. After providing the discharge gas into the discharge spaces 140, a high frequency power such as a radio frequency (RF) power is applied to the getter 200 positioned in at least one of the discharge spaces 140, and a mercury gas is provided into the discharge spaces 140. Accordingly, the discharge gas and the mercury gas are mixed in the discharge space 140. In such a case, while an internal pressure of the discharge space 140 is about 50 Torr to about 70 Torr, an external pressure of the discharge space 140 is about 760 Torr as atmospheric pressure. Accordingly, a pressure difference between the internal and external pressures of the discharge space 140 generates a compressive force applied to the second substrate 120 such that the interval portions 124 of the second substrate 120 adhere closely to the first substrate 110 due to the pressure difference.

The flat fluorescent lamp 100 further includes a reflective layer 160, a first fluorescent layer 170 and a second fluorescent layer 180. The reflective layer 160 is formed on the top surface of the first substrate 110 facing the bottom surface of the second substrate 120, and the first fluorescent layer 170 is formed on the reflective layer 160. The second fluorescent layer 180 is formed on the bottom surface of the second substrate 120. The reflective layer 160 and the first and second fluorescent layers 170 and 180 may be formed in a shape of a thin film by a spraying process before combining the first substrate 110 with the second substrate 120. An opening 190 is formed at a selected position of the reflective layer 160 and the first fluorescent layer 170. In this embodiment, the opening 190 is a through-hole formed in the reflective and first fluorescent layers 160 and 170. The getter 200 is received in the opening 190 on the first substrate 110.

The reflective layer 160 reflects a visible light generated from the first and second fluorescent layers 170 and 180, thereby preventing a leakage of the visible light through the second substrate 120. The reflective layer 160 is coated on the entire surface of the first substrate 110 except for the opening 190 and a peripheral portion corresponding to the edge portion 126 of the second substrate 120, and comprises, e.g., a metal oxide in order to improve a reflectivity and suppress a variation of color indexes. Examples of the reflective layer 160 include an aluminum oxide layer, a barium sulfate layer, etc. These may be used alone or in combinations thereof.

Electrons of the first and second fluorescent layers 170 and 180 are excited by the ultraviolet light generated by a plasma discharge in the discharge spaces 140, and thus the visible light is generated from the first and second fluorescent layers 170 and 180. The first fluorescent layer 170 is coated on the entire top surface of the first substrate 110 except for the opening 190 and the peripheral portion of the first substrate 110 corresponding to the edge portion 126 of the second substrate 120. The second fluorescent layer 180 is coated on the entire bottom surface of the second substrate 120 except for the edge portion 126 on which the sealing member may be disposed.

The getter 200 is positioned in at least one of the discharge spaces 140. The getter 200 includes the body portion 210 and the wing portion 220 for securing the body portion 210 to the first substrate 110. The wing portion 220 is protruded bi-directionally from the body portion 210 and symmetrically with respect to the body portion 210, extending a predetermined distance therefrom. The getter 200 is positioned on the first substrate 110 through the opening 190, so that the wing portion 220 makes close contact with the reflective layer 160 and the first fluorescent layer 170. As a result, the getter 200 is secured to the first substrate 110 in the opening 190. In addition, when the first and second substrates 110 and 120 are combined with each other, the interval portions 124 of the second substrate 120 suppress the wing portion 220 of the getter 200, and thus the getter 200 is more firmly secured to the first substrate 110. In an exemplary embodiment, the wing portion 220 has a thickness substantially identical to a thickness summation of the reflective layer 160 and the first fluorescent layer 170. For example, when the reflective layer 160 has a thickness of about 150 μm and the first fluorescent layer 170 has a thickness of about 20 μm, the wing portion 220 is formed to have a thickness of about 170 μm.

As shown in the embodiment of FIG. 1, the getters 200 are positioned at four corner portions of the first substrate 110. In alternative embodiments, the getters 200 may be positioned, for example, at two corner portions diagonally opposite to each other or at both sides of the center portion of the first substrate 110. However, it will be understood that the getters 200 may be positioned at various portions of the first substrate 110 provided that the mercury gas spreads through all of the discharge spaces 140 as rapidly as possible.

The flat fluorescent lamp 100 further includes an electrode 130 formed on the bottom surface of the first substrate 110. The electrode 130 extends in a direction substantially perpendicular to a direction in which the recessed portions 122 of the second substrate 120 extend, so that the electrode 130 traverses all the discharge spaces 140. The electrode 130 comprises a material of high electrical conductivity and high process facility. In an exemplary embodiment, a silver paste, consisting of, e.g., a mixture of silver (Ag) and silicon dioxide (SiO2), is coated on the bottom surface of the first substrate 110, and the electrode 130 is formed on the bottom surface of the first substrate 110. Alternatively, a metal powder is sprayed on the bottom surface of the first substrate 110 and a metal thin layer is coated on the first substrate 110, thereby forming the electrode 130. The metal powder comprises, e.g., copper, nickel, silver, gold or chromium. These may be used alone or in combinations thereof.

A discharge voltage for driving the flat fluorescent lamp 100 is applied to the electrode 130 via an external inverter (not shown). An insulation layer (not shown) may be further formed on the electrode 130, so that the electrode 130 is protected and insulated from its surroundings. While the electrode 130 is described herein as formed on the bottom surface of the first substrate 110, it will be understood by those skilled in the art that the electrode 130 could otherwise be formed on the top surface of the second substrate 120 or any other suitable positions. The electrode 130 is not positioned under the getter 200, so that the electrode 130 and the getter 200 are arranged without overlapping with each other. When the getter 200 is overlapped with the electrode 130, light generation characteristics of the flat fluorescent lamp 100 may be deteriorated by a mutual electrical interference between the electrode 130 and the getter 200. Therefore, the getter 200 is positioned in such a region that the electrode 130 has no electrical effect on the getter 200. For that reason, the getter 200 is positioned without overlapping with the electrode 130, and more particularly, is positioned in an effective light generation region in which an effective light for displaying images is substantially generated. When the getter 200 is positioned in the effective light generation region, a dark portion may be generated on a display panel. Therefore, a reflective material (not shown) is coated on a surface of the getter 200 so as to eliminate the dark portion.

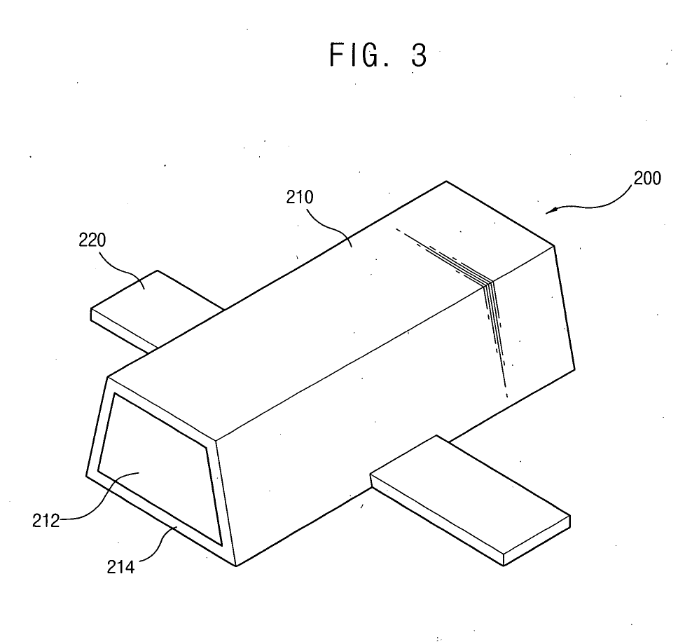

FIG. 3 is an enlarged perspective view illustrating the getter 200 in FIG. 1.

Referring to FIG. 3, the getter 200 includes the body portion 210 and the wing portion 220 bi-directionally protruding from the body portion 210. The body portion 210 includes a source 212 comprising an amalgam and a cover 214 surrounding the source 212.

The amalgam includes an alloy of mercury and other metal. When a high frequency power, such as a radio frequency power, is applied to the getter 200, the amalgam material provides a mercury gas for a plasma discharge into the discharge space 140. Examples of the amalgam may include an alloy of mercury (Hg) and titanium (Ti), an alloy of mercury (Hg) and sodium (Na), etc. The source 212 is prevented from being damaged by the cover 214 surrounding the source 212. As an exemplary embodiment, the cover 214 comprises a metal layer coated on the source 212. For example, an iron (Fe) layer is coated on the source 212 and a nickel (Ni) layer is coated on the iron (Fe) layer.

The source 212 further includes a gathering alloy to which impurities in the discharge space 140 are adhered. A very small quantity of the impurity gas such as carbon monoxide (CO), nitrogen (N₂), carbon dioxide (CO₂), oxygen (O₂) and water vapor (H₂O) remains in the discharge space 140 even though air in the discharge spaces 140 is sufficiently exhausted. The above impurity gas may shorten an endurance of the flat fluorescent lamp 100 and deteriorate light generation characteristics of the flat fluorescent lamp 100. The gathering alloy of the source 212 absorbs the impurity gas in the discharge spaces 140, and the absorbed impurity gas is eliminated from the discharge space 140, thereby improving the endurance of the flat fluorescent lamp 100. For example, the gathering alloy may be comprised of an alloy of zirconium and aluminum.

In an exemplary embodiment, the wing portion 220 of the getter 200 is bi-directionally protruding from the body portion 210 and symmetrical with respect to the body portion 210. The wing portion 220 makes partial contact with the interval portions 124 of the second substrate 120. The thickness of the wing portion 220 is substantially identical to a thickness summation of the reflective layer 160 and the first fluorescent layer 170. In an exemplary embodiment, the wing portion 220 has a smallest possible width so as to decrease a contact area with the first substrate 110. The wing portion 220, for example, may be comprised of a material identical to that of the cover 214.

As shown in FIG. 3, the body portion 210 of the getter 200 has, for example, a trapezoidal shape. However, it will be understood by those skilled in the art that the body portion 210 of the getter 200 may have various shapes such as a rectangular cylinder and a circular cylinder.

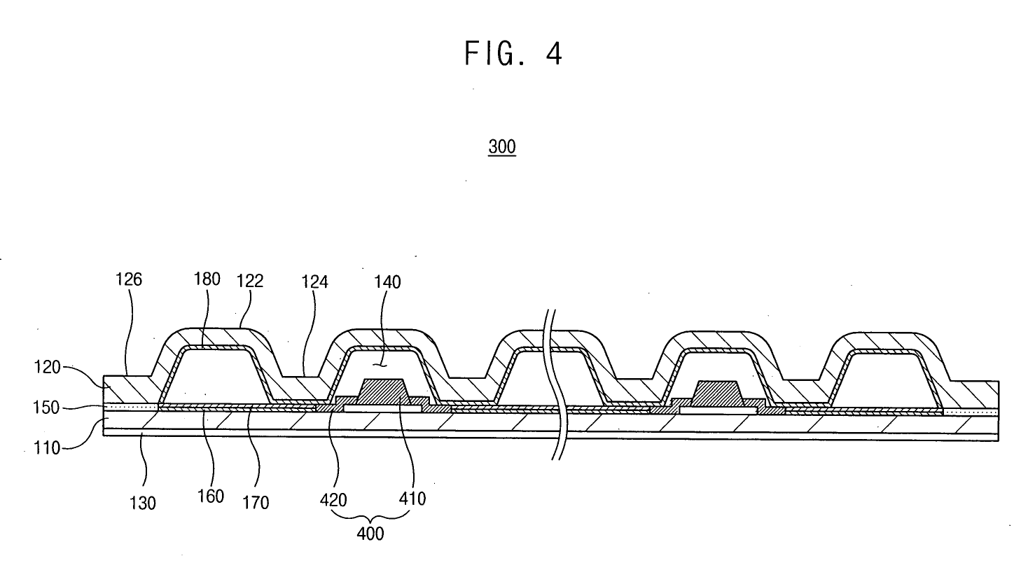

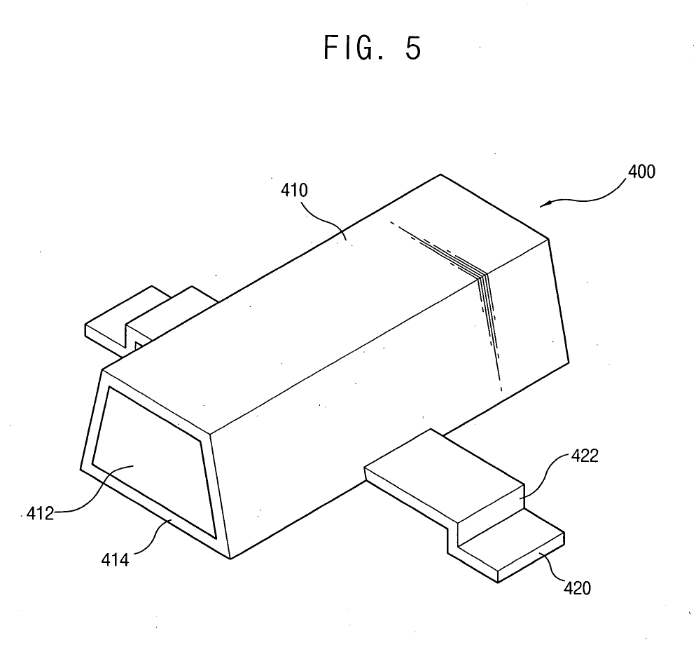

FIG. 4 is a cross-sectional view illustrating a flat fluorescent lamp according to another exemplary embodiment of the present invention. FIG. 5 is a perspective view of the getter shown in FIG. 4. In FIGS. 4 and 5, the same reference numerals denote the same elements in FIG. 2, and thus the detailed descriptions of the same elements will be omitted.

Referring to FIGS. 4 and 5, a flat fluorescent lamp 300 according to an alternative exemplary embodiment includes a getter 400 disposed in at least one of the discharge spaces 140. The getter 400 includes a body portion 410 and a wing portion 420 for securing the body 410 to the first substrate 110. The wing portion 410 is bi-directionally protruding from the body portion 410 and is symmetrical with respect to the body portion 410. The body portion 410 of the getter 400 has the same structure as the body portion 210 described with reference to FIG. 3, so that any further description on the body portion 410 will be omitted.

The wing portion 420 includes a bended portion 422 for separating the body portion 410 from the first substrate 110. An end portion of the wing portion 420 is bended downwardly, so that when the bended portion 422 makes contact with the first substrate 110, the body portion 410 of the getter 400 is spaced apart from the first substrate 110 by a predetermined distance, thereby sufficiently preventing a thermal conduction between the body portion 410 of the getter 400 and the first substrate 110. The RF power is applied to the getter 400 for about 30 seconds at a temperature of about 900° C. so as to provide the mercury gas into the discharge space 140 (hereinafter, referred to as a getter flashing process), and the body portion 410 of the getter 400 is heated to a high temperature during the getter flashing process. As a result, if the body portion 410 makes direct contact with the first substrate 110, the heat may be transferred to the first substrate 110 from the body portion 410 due to a thermal conduction, thereby causing damage to the first substrate 110. However, the body portion 410 of the getter 400 is spaced apart from the first substrate 110 due to the bended portion 422, so that the heat transfer from the body portion 410 to the first substrate 110 is sufficiently prevented.

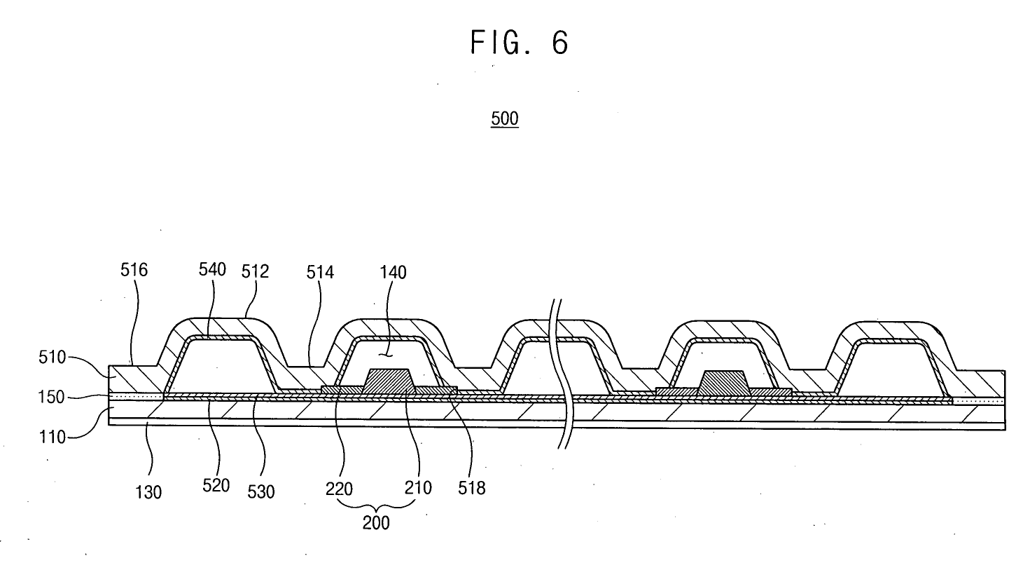

FIG. 6 is a cross-sectional view illustrating a flat fluorescent lamp according to still another exemplary embodiment of the present invention. The present embodiment is substantially identical to the above embodiment described with reference to FIG. 2 except for the second substrate, the reflective layer and the first and second fluorescent layers, so that in FIG. 6, the same reference numerals denote the same elements in FIG. 2, and any further detailed descriptions concerning the same elements will be omitted.

Referring to FIG. 6, a flat fluorescent lamp 500 according to still another exemplary embodiment of the present invention includes a second substrate 510 combining with the first substrate 110, a reflective layer 520 formed on the top surface of the first substrate 110 and a first fluorescent layer 530 formed on the reflective layer 520. In a similar way as described with reference to FIGS. 2 and 3, a plurality of recessed portions 512 are formed on the bottom surface of the second substrate 510 in parallel with, and spaced apart from, each other. When the first and second substrates 110 and 510 are combined with each other, the second substrate 510 makes contact with the first substrate 110 at a plurality of interval portions 514 between the recessed portions 512, and is spaced apart from the first substrate 110 at the recessed portions 512 by a predetermined recessed depth. Accordingly, the discharge space 140 is formed between the first substrate 110 and the recessed portion 512 of the second substrate 510. An edge portion 516 of the second substrate 510 is also combined with the first substrate 110, and a sealing member (not shown) is formed on the edge portion 516 of the second substrate 510. The bottom surface of the second substrate 510 corresponding to the interval portions 514 between which the getter 200 is positioned is partially removed symmetrically with respect to the body portion 210 of the getter 200, so that a holding portion is partially formed on the bottom surface of the interval portions 514.

The reflective layer 520 is formed on the top surface of the first substrate 110 facing the bottom surface of the second substrate 510, and the first fluorescent layer 530 is formed on the reflective layer 520. In an exemplary embodiment, the reflective layer 520 and the first fluorescent layer 530 are sequentially coated on a whole surface of the first substrate 110 except for a peripheral portion corresponding to the edge portion 516 of the second substrate 510. The second fluorescent layer 540 is formed on the bottom surface of the second substrate 510 except for the edge portion 516 on which the sealing member is to be positioned and the holding portion.

When the first and second substrates 110 and 510 are combined with each other, a holding space 518 is formed between the second fluorescent layer 540 and the holding portion of the interval portion 514, and the wing portion 220 of the getter 200 is inserted into the holding space 518, thereby securing the getter 200 to the first substrate 110. In an exemplary embodiment, the reflective layer 520 and the first fluorescent layer 530 prevent the heat transfer from the body portion 210 of the getter 200 to the first substrate 110.

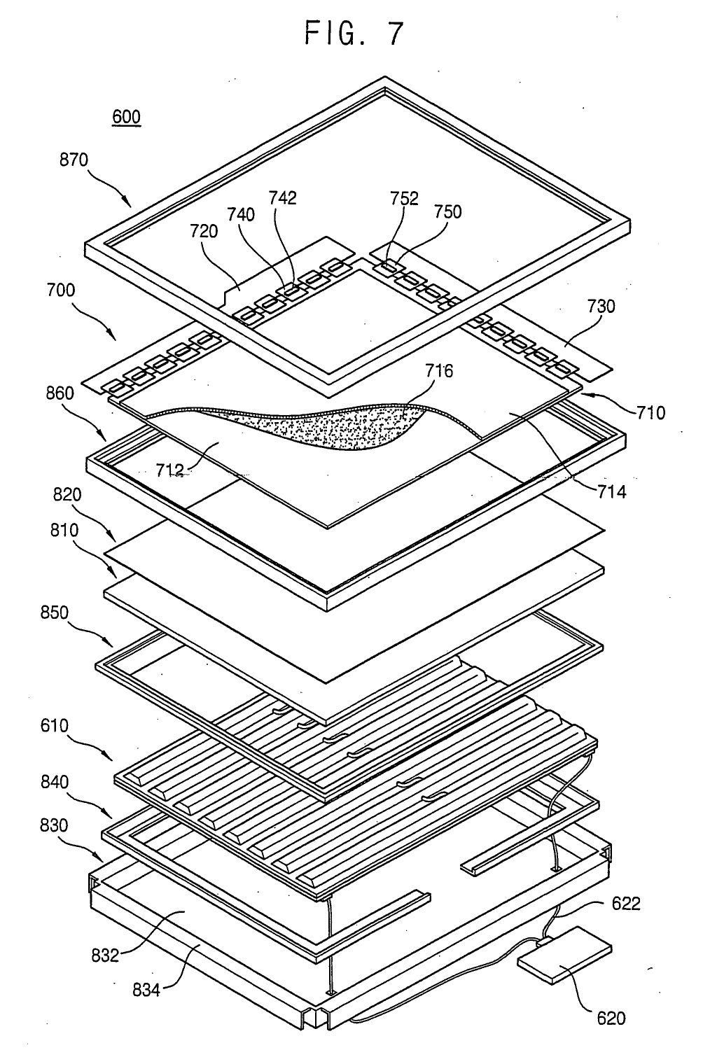

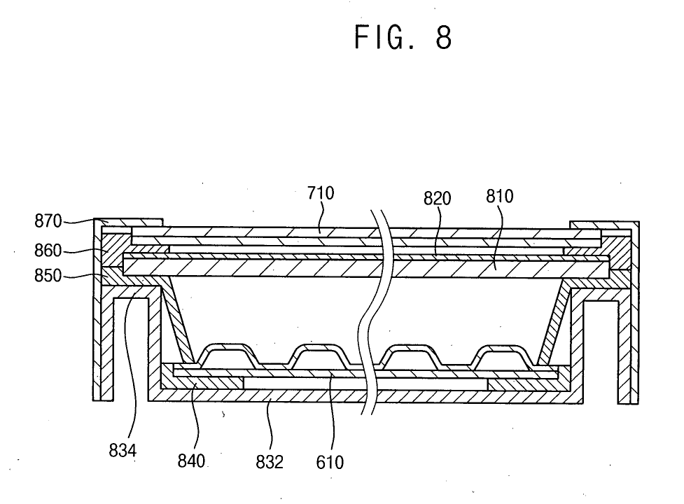

FIG. 7 is an exploded perspective view illustrating a liquid crystal display apparatus according to an exemplary embodiment of the present invention. FIG. 8 is a cross-sectional view illustrating the liquid crystal display apparatus shown in FIG. 7.

Referring to FIGS. 7 and 8, a liquid crystal display apparatus 600 in accordance with an embodiment of an exemplary embodiment includes a flat fluorescent lamp 610 for generating light, an inverter 620 for applying a discharge voltage to the a flat fluorescent lamp 610 and a display unit 700 for displaying an image. The flat fluorescent lamp 610 has the same structure as described with reference to FIGS. 1 to 6, and thus any further detail descriptions on the flat fluorescent lamp 610 will be omitted. The discharge voltage for driving the flat fluorescent lamp 610 is applied via the inverter 620. A low frequency of an external alternating voltage is inverted into a sufficiently high frequency for driving the flat fluorescent lamp 610, and thus the discharge voltage having a high frequency is generated in the inverter 620. The inverter 620 is positioned outside of a receiving container 830, for example, on a rear surface of the receiving container 830. The discharge voltage generating from the inverter 620 is applied to the electrode of the flat fluorescent lamp 610 through a lamp wire 622.

The display unit 700 includes a liquid crystal panel 710, a data printed circuit board 720 and a gate printed circuit board 730. The liquid crystal display panel 710 displays images by using a light generated from the flat fluorescent lamp 610. The data printed circuit board 720 and a gate printed circuit board 730 provide the liquid crystal display panel 710 with driving signals. The driving signals generated from the data printed circuit board 720 and gate printed circuit board 730 are applied to the liquid crystal display panel 710 through a data flexible circuit film 740 and a gate flexible circuit film 750, respectively. The data and gate flexible circuit films 740 and 750, for example, include a tape carrier package (TCP) or a chip on film (COF). The data flexible circuit film 740 includes a data-driving chip 742 for applying a well-timed data-driving signal, which is generated from the data printed circuit board 720, to the liquid crystal display panel 710, and the gate flexible circuit film 750 includes a gate-driving chip 752 for applying a well-timed gate-driving signal, which is generated from the gate printed circuit board 730, to the liquid crystal display panel 710.

In an exemplary embodiment, the data flexible circuit film 740 is bent downwardly, and the data printed circuit board 720 is positioned on a side or a rear surface of the receiving container 830. In the same way, the gate flexible circuit film 750 is also bent downwardly, and the gate printed circuit board 730 is positioned on a side or a rear surface of the receiving container 830. Meanwhile, the gate printed circuit board 730 may be omitted when signal wires (not shown) are formed on the liquid crystal display panel 710 and the gate flexible circuit film 750.

The liquid crystal display panel 710 includes a thin film transistor (hereinafter, referred to as TFT) substrate 712, a color filter substrate 714 facing the TFT substrate 712 and a liquid crystal layer 716 interposed between the TFT substrate 712 and the color filter substrate 714.

The TFT substrate 712 exemplarily includes a transparent glass on which a plurality of TFTs (not shown) are arranged in a matrix shape. A source electrode of the TFT is electrically connected to a data line, and a gate electrode of the TFT is electrically connected to a gate line. A drain electrode of the TFT is electrically connected to a pixel electrode (not shown) comprising a conductive transparent material.

A color filter such as red, green and blue (RGB) unit pixels is coated on the color filter substrate 714 by a thin film process. A common electrode (not shown) comprising a conductive transparent material is formed on the color filter substrate 714.

When an electrical power is applied to the gate electrode of the TFT 712 and then the TFT 712 is turned on, an electrical field is generated between the pixel electrode and the common electrode. Accordingly, a molecular arrangement of the liquid crystal layer 716 is changed in accordance with the electrical field, and a transmissivity of the light provided from the flat fluorescent lamp 610 is also varied in accordance with the change of the molecular arrangement, thereby displaying images on the liquid crystal display panel 710 by a predetermined gray scale.

The liquid crystal display apparatus 600 further includes a diffusing plate 810 and an optical sheet 820. The diffusing plate 810 is positioned over the flat fluorescent lamp 610 and diffuses the light generated from the flat fluorescent lamp 610, and the optical sheet is positioned on the diffusing plate 810.

The diffusing plate 810 diffuses the light generated from the flat fluorescent lamp 610, thereby enhancing uniformity of luminance of the light. In an exemplary embodiment, the diffusing plate 810 includes a plate comprising poly methyl methacrylate (PMMA), and is spaced apart from the flat fluorescent lamp 610 by a predetermined distance.

The optical sheet 820 changes a path of the diffused light passing through the diffusing plate 810, thereby further enhancing the luminance of the light. As an exemplary embodiment, the optical sheet 820 further includes a condensing sheet (not shown) for condensing the diffused light in a direction in which a user views the LCD panel in front of the LCD panel, thereby enhancing a front luminance of the light. The optical sheet 820 may further include a diffusing sheet (not shown) for re-diffusing the diffused light by the diffusing plate 810. Various sub-sheets for performing various optical functions may be added to or removed from the optical sheet 820 in accordance with desirable luminance characteristics of the liquid crystal display apparatus 600, as would be known to one of ordinary skill in the art.

The receiving container 830 for receiving the flat fluorescent lamp 610 exemplarily includes a bottom plate 832 and sidewalls 834 extending upwardly from a peripheral portion of the bottom plate 832. The bottom plate 832 supports the flat fluorescent lamp 610, and a receiving space in which the flat fluorescent lamp 610 is positioned is defined by the sidewalls 834. As shown in FIG. 7, the sidewall 834 is bent at a right angle outwardly with respect to the receiving space, and then an end portion of the sidewall 834 is secondly bent at a right angle downwardly toward the bottom plate 832. Accordingly, a shallow inserting area is formed between the secondly-bended portion and the non-bended portion of the sidewall 834, so that an assembly facility of the liquid crystal display apparatus 600 in an operation space is improved. For example, a securing member (not shown) may be inserted into the inserting area for securing the liquid crystal display apparatus 600 to a proper position of the operation space. In the present embodiment, the receiving container 830 may be comprised of a metal because of its high strength and deformation-resistance thereof.

The liquid crystal display apparatus 600 may further include an insulating member 840 that is interposed between the flat fluorescent lamp 610 and the receiving container 830 and supports the flat fluorescent lamp 610. The insulating member 840 is positioned along a peripheral portion of the flat fluorescent lamp 610, so that the flat fluorescent lamp 610 does not make direct contact with the receiving container 830. As a result, the flat fluorescent lamp 610 is electrically insulated from the receiving container 830 by the insulating member 840 comprising an insulation material. In addition, the insulating member 840 may be comprised of an elastic material such as silicon so as to absorb an external impact. As shown in FIG. 7, the insulating member 840 includes two ‘U’-shaped pieces, so that the whole peripheral portion is supported in a width direction, and some of the peripheral portion is not supported in a longitudinal direction of the flat fluorescent lamp 610. Although the above exemplary embodiment discloses two U-shaped pieces as the insulating member 840, a four-piece configuration, a frame-shaped configuration or any other configuration known to one of ordinary skill in the art may also be utilized as the insulating member 840 in place of the two-piece configuration. The four-piece configuration may support each side or each corner of the flat fluorescent lamp 610, and the frame-shaped configuration may support the whole peripheral portion of the flat fluorescent lamp 610.

The liquid crystal display apparatus 600 may further include a first mold 850 interposed between the flat fluorescent lamp 610 and the diffusing plate 810. The first mold 850 secures the flat fluorescent lamp 610 to the receiving container 830 and supports the diffusing plate 810. The first mold 850 makes contact with an edge portion of a top surface of the flat fluorescent lamp 610 and is assembled to the sidewall 834 of the receiving container 830, so that the flat fluorescent lamp 610 is secured to the receiving container 830. Although the present embodiment exemplarily discloses a frame configuration as the first mold 850, a two-piece U-shaped or L-shaped configuration or any other configuration known to one of ordinary skill in the art may also be utilized as the first mold 850 in place of the frame configuration.

The liquid crystal display apparatus 600 may further include a second mold 860. The second mold 860 is positioned between the optical sheet 820 and the liquid crystal panel 710. The second mold 860 prevents the optical sheet 820 and the diffusing plate 810 from being moved, and supports the liquid crystal display panel 710. In the same way as the first mold 850, although a frame configuration is utilized as the second mold 860 in the present embodiment, a two-piece U-shaped or L-shaped configuration or any other configuration known to one of ordinary skill in the art may also be utilized as the second mold 860 in place of the frame configuration.

The liquid crystal display apparatus 600 may further include a top chassis 870. The top chassis surrounds peripheral portions of the liquid crystal display panel 710, and is combined with the receiving container 830, so that the liquid crystal display panel 710 is secured to an upper portion of the second mold 860. The top chassis 870 protects the liquid crystal display panel 710 from an external impact and prevents the liquid crystal display panel 710 from being separated from the second mold 860.

According to the flat fluorescent lamp and the liquid crystal display apparatus, an exhaustion tube for mounting the getter is no longer required for the flat fluorescent lamp, thereby decreasing a thickness of the flat fluorescent lamp and preventing a processing failure that is often caused by the exhaustion tube, and the getter is more safely implemented in the discharge space due to the wing portion. Moreover, a body portion of the getter is spaced apart from the substrate in the discharge space, thereby minimizing defects due to the thermal conduction.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A flat fluorescent lamp comprising:
a first substrate;
a second substrate combined with the first substrate;
a discharge space formed between the first substrate and the second substrate; and
a getter disposed in the discharge space, the getter including a body portion and a wing portion for securing the body portion.

2. The flat fluorescent lamp of claim 1, wherein the getter is disposed on the first substrate, the wing portion being configured to secure the body portion to the first substrate.

3. The flat fluorescent lamp of claim 1, wherein the body portion of the getter includes a source having an amalgam material and a cover surrounding the source.

4. The flat fluorescent lamp of claim 3, wherein the source includes a gathering alloy to which impurities in the discharge space are adhered.

5. The flat fluorescent lamp of claim 3, wherein the cover includes a metal layer having iron (Fe) and nickel (Ni).

6. The flat fluorescent lamp of claim 1, wherein the second substrate includes a plurality of protruded portions arranged in substantially parallel with and spaced apart from each other, and an interval portion formed between adjacent ones of the protruded portions, the first substrate making contact with the interval portion and an edge portion of the second substrate, the discharge space being formed between the first substrate and a recessed portion of which surface is opposite to a surface of corresponding one of the protruded portions of the second substrate.

7. The flat fluorescent lamp of claim 6, wherein the wing portion bi-directionally extends from the body portion and being symmetrical with respect to the body portion.

8. The flat fluorescent lamp of claim 7, further comprising:
a reflective layer formed on a top surface of the first substrate facing a bottom surface of the second substrate;
a first fluorescent layer formed on the reflective layer; and
a second fluorescent layer formed on the bottom surface of the second substrate.

9. The flat fluorescent lamp of claim 8, wherein the reflective layer and the first fluorescent layer have an opening for receiving the getter.

10. The flat fluorescent lamp of claim 8, wherein a thickness of the wing portion is substantially equal to a thickness of the reflective layer and the first fluorescent layer.

11. The flat fluorescent lamp of claim 7, wherein a bottom surface of the second substrate corresponding to the interval portion between which the getter is disposed is partially removed, so that a holding space for receiving the wing portion of the getter is formed between the first substrate and the interval portion of the second substrate.

12. The flat fluorescent lamp of claim 6, further comprising at least one connecting member on the interval portion of the second substrate, so that adjacent ones of the discharge spaces are connected through the connecting member.

13. The flat fluorescent lamp of claim 12, wherein air in the discharge space is exhausted through the connecting member forming a vacuum therein; and discharge gases for accelerating a plasma discharge are provided into the discharge space through the connecting member.

14. The flat fluorescent lamp of claim 1, wherein the wing portion of the getter includes a bent portion, so that the body portion of the getter is spaced apart from the first substrate.

15. The flat fluorescent lamp of claim 1, further comprising an electrode on at least one of a bottom surface of the first substrate and a top surface of the second substrate, the electrode traversing the discharge space.

16. The flat fluorescent lamp of claim 15, wherein the getter is positioned without overlapping the electrode.

17. The flat fluorescent lamp of claim 16, wherein a reflective material is coated on a surface of the getter.

18. A liquid crystal display apparatus comprising:
a flat fluorescent lamp including: a first substrate; a second substrate combined with the first substrate to form a discharge space between the first and second substrates; and a getter disposed in the discharge space, the getter having a body portion and a wing portion for securing the body portion;
an inverter applying a discharge voltage to the flat fluorescent lamp; and
a liquid crystal panel displaying images by using light generated from the flat fluorescent lamp.

19. The liquid crystal display apparatus of claim 18, wherein the body portion of the getter includes:
a source having an amalgam material and a gathering alloy to which impurities in the discharge space are adhered; and
a cover surrounding the source.

20. The liquid crystal display apparatus of claim 18, wherein the second substrate includes a plurality of protruded portions arranged in substantially parallel with and spaced apart from each other, an interval portion formed between adjacent ones of the protruded portions, the first substrate making contact with the interval portion and an edge portion of the second substrate, the discharge space being formed between the first substrate and a recessed portion of which surface is opposite to a surface of corresponding one of the protruded portions of the second substrate.

21. The liquid crystal display apparatus of claim 20, wherein the wing portion bi-directionally extends from the body portion and being symmetrical with respect to the body portion of the getter.

22. The liquid crystal display apparatus of claim 21, wherein the flat fluorescent lamp comprises:
a reflective layer disposed on a top surface of the first substrate facing a bottom surface of the second substrate;
a first fluorescent layer disposed on the reflective layer; and
a second fluorescent layer disposed on the bottom surface of the second substrate, an opening for receiving the getter being formed through the reflective layer and the first fluorescent layer, a thickness of the wing portion being substantially equal to a thickness of the reflective layer and the first fluorescent layer.

23. The liquid crystal display apparatus of claim 21, wherein a bottom surface of the second substrate corresponding to the interval portion between which the getter is disposed is partially removed, so that a holding space for receiving the wing portion of the getter is formed between the first substrate and the interval portion of the second substrate.

24. The liquid crystal display apparatus of claim 18, wherein the wing portion of the getter includes a bent portion, so that the body portion of the getter is spaced apart from the first substrate.

25. The liquid crystal display apparatus of claim 18, further comprising an electrode on at least one of a bottom surface of the first substrate and a top surface of the second substrate, the electrode traversing the discharge space.

26. The liquid crystal display apparatus of claim 25, wherein the getter is positioned without overlapping the electrode, and a reflective material is coated on a surface of the getter.

27. The liquid crystal display apparatus of claim 18, further comprising:
a diffusing plate disposed over the flat fluorescent lamp, the diffusing plate diffusing light generated from the flat fluorescent lamp; and
an optical sheet disposed over the diffusing plate.

28. The liquid crystal display apparatus of claim 27, further comprising:
a receiving container receiving the flat fluorescent lamp;
an insulating member disposed between the flat fluorescent lamp and the receiving container;
a first mold securing the flat fluorescent lamp and supporting the diffusing plate; and
a second mold securing the diffusing plate and the optical sheet and supporting the liquid crystal display panel.
